(19) United States
(12) Patent Application Publication
(10) Pub. No.: US 2026/0307752 A1
(43) Pub. Date: Oct. 8, 2026

(54) SUPPORT ELEMENT FOR THE HUMAN BODY COMPRISING A RECYCLED MATERIAL AND METHOD FOR ITS PRODUCTION

(71) Applicant: SELLE ROYAL GROUP S.P.A., Pozzoleone (Vicenza) (IT)

(72) Inventors: Barbara BIGOLIN, Pozzoleone (Vicenza) (IT); Matteo MASON, Pozzoleone (Vicenza) (IT)

(21) Appl. No.: 19/481,780

(22) PCT Filed: Apr. 30, 2024
(86) PCT No.: PCT/IB2024/054171

§ 371 Date: Nov. 5, 2025

(30) Foreign Application Priority Data
May 5, 2023 (IT) 102023000008919

(51) Int. Cl. B62J 1/18; B29B 17/04; B29C 44/12; B29C 44/44; B29K 105/26; B29L 31/30; B62K 21/26

(52) U.S. Cl. CPC B62J 1/18; B29B 17/0412; B29C 44/12; B29C 44/445; B62K 21/26; B29B 2017/042; B29K 2105/26; B29L 2031/3094

(57) ABSTRACT

The present invention refers to a support element for the human body including a recycled material in the form of granules, wherein these granules are made up of at least two materials different in type and/or hardness and/or density and/or stiffness; and a method for making it or for making a padding element of such support element.

### TECHNICAL FIELD OF THE INVENTION

The present invention concerns a support element for the human body, such as a saddle of a bicycle or a vehicle in general, a seat, a grip for a handlebar of a bicycle or of a vehicle in general, etc., comprising a recycled material. Furthermore, the present invention also refers to a method for manufacturing such a support element.

### STATE OF THE PRIOR ART

The problem of being able to obtain a product that is sustainable from an environmental point of view is now widespread across all sectors.

Similarly, the need to reduce waste and reduce production waste is increasingly felt.

In particular, it should be remembered that often commonly used objects, such as bicycle saddles, being made of different types of materials, cannot be recycled and the material that composes them-as far as possible-can only be recovered in minimal part. On the sidelines, we must remember the enormous costs that each company must bear for the disposal of waste and production waste, which therefore becomes unsustainable both from an economic and ecological point of view.

The applicant has long been committed to the creation of increasingly eco-friendly products, see for example patent applications EP2139751 and EP2736795. However, none of these objects is capable of reaching a degree of eco-friendliness that is capable of satisfying current needs.

International application no. W02007/049973 describes a mould in which pieces or flakes of polyurethane foam are led together with a binder into a closed mould. A compression step takes place in this mould and then steam is introduced to polymerize the resulting product, for example a cushion for a chair or a stool, which is then cooled.

Application no. DE 102021115436 describes a seat for a vehicle provided with a cushion having at least one foam element, a covering that at least partially covers an external surface of the cushion and a heating device for the seat itself. The foam element comprises metal granules designed to act as a heat conducting element.

Application no. EP3838543 describes a method for producing a cushion for a seat element of a motor vehicle, wherein this method involves the steps of mixing particles of elastically compressible foam and/or recycled fibers with a precursor mixture of a flexible polyurethane resin in order to glue said particles and/or fibers together, so as to obtain a mixture suitable for forming a padding block for the cushion itself.

Also in this method there is a step of compressing the material inserted into the mould in order to make it take the shape of the cavity in which it is placed.

The possibility of preparing a further product and a method that are more ecologically sustainable, which help to reduce waste and scraps or which manage to eliminate them completely, and which at the same time maintain the functional characteristics of the resulting product unaltered, for example the mechanical and comfort properties, therefore assumes considerable importance.

### SUMMARY OF THE INVENTION

An object of the present invention is to overcome the drawbacks of the known art.

Another object of the present invention is to provide a support element for the human body that comprises a recycled material.

A further object of the present invention is to provide a support element for the human body that is environmentally friendly.

A yet further object of the present invention is to provide a support element for the human body which has optimal functionality, in terms of mechanical performance and comfort.

In accordance with one aspect of the invention, a support element for the human body according to the present application is provided.

An object of the present invention is to provide a method for making a support element for the human body that is simple and rapid.

A further object of the present invention is to provide a method for manufacturing a support element for the human body that is more ecologically sustainable.

Another object of the present invention is to provide a method for manufacturing a support element for the human body which is substantially compatible with traditional production plants.

In accordance with an aspect of the invention there is provided a method for the production of a support element for the human body according to the present application and a method for the production of a padding element according to the present application.

The present application refers to preferred and advantageous embodiments of the invention.

### BRIEF DESCRIPTION OF THE DRAWINGS

Other characteristics and advantages of the invention will be more evident from the description of an embodiment of the present invention, illustrated by way of example in the attached drawings in which:

FIG. 1A and 1B are two top views of two versions of a support element for the human body according to the present invention in the form of a bicycle saddle;

FIG. 2 is a top view of a further embodiment of a support element for the human body according to the present invention in the form of a bicycle saddle;

FIG. 3 illustrates a perspective view of a further embodiment of a support element for the human body according to the present invention in the form of a grip for a bicycle handlebar;

FIG. 4 illustrates a perspective view of a further embodiment of a support element for the human body according to the present invention in the form of a grip for a bicycle handlebar; and

FIG. 5 represents a block diagram relating to at least part of the steps of the method according to the present invention.

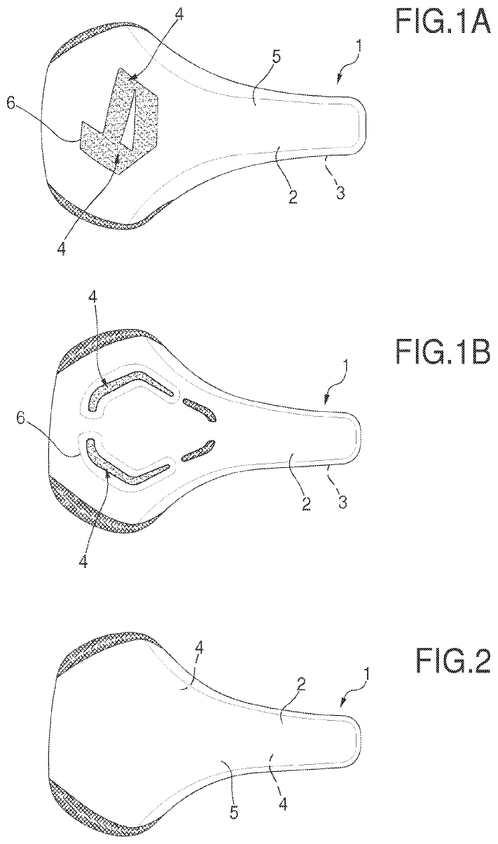

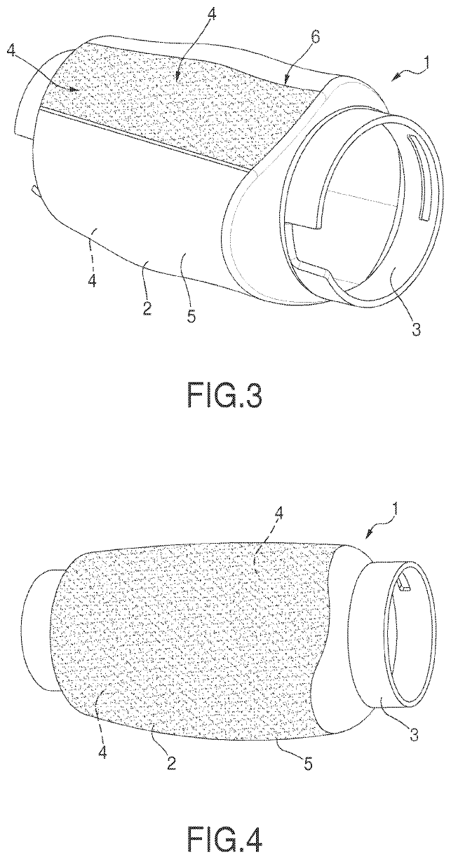

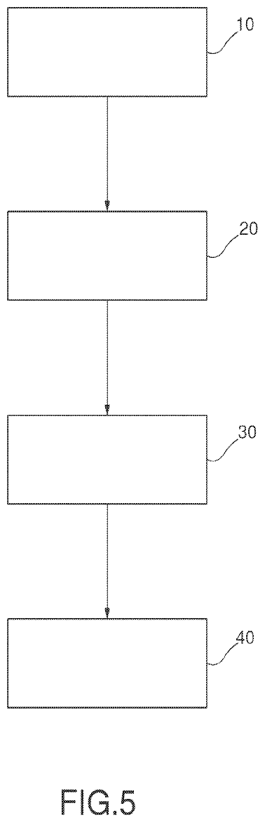

In the attached drawings, identical parts or components are identified by the same reference numbers.

### DETAILED DESCRIPTION OF THE INVENTION

A support element for the human body, such as a bicycle saddle, comprises a padding, whether or not equipped with an external covering (also called cover) which envelops it at its external or visible surface, and a plastic base support, for example called “hull” or “felt” in bicycles. In most cases, a “fork” can be attached to the plastic base, for example made of metallic material, to connect the saddle to a seat post of a bicycle frame.

Naturally, there may be adhesive materials between the padding and the support base and/or between the padding and the cover.

The support element 1 according to the present invention can be a bicycle or vehicle saddle, a seat, a grip for a handlebar of a bicycle or for a vehicle, etc. In essence, the support element 1 is able to support the weight of a user or a part of a user's body, at the same time ensuring an appropriate level of comfort.

The support element 1 includes a padding element 2, which can be constrained to at least one surface of a support base 3.

In at least one version of the present invention, the support base 3 is present and is constrained to the padding element 2.

In at least one version of the present invention, for example when the support element 1 is a bicycle or vehicle saddle, a seat, etc., the support base 3 is not embedded inside the padding element 2 but constitutes an element which, in the finished support element 1, remains at least partially visible and with at least one of its surfaces constrained to the padding element 2.

The padding element 2 can include at least one gel or elastomer insert, generally placed at and/or close to an external or visible surface of the support element 1, and a component in expanded material, for example made in a foam, for example polyurethane foam, a self-skinning polyurethane foam, an expanded polyurethane polymer formed by the reaction of a material A, such as for example isocyanate, and a material B, such as for example a polyol formulation comprising at least one polyol and at least one additive such as at least one of a catalyst, a cell regulator, a colour, etc., an expanded thermoplastic or EVA, a foam material having a density between 50 and 600 kg/m³ , or a combination thereof.

The at least one gel or elastomer insert can be made of a polyurethane gel or an elastomeric material.

In an alternative version, the padding element 2 is completely made up of the component in expanded material.

The padding element 2 and/or its component in expanded material comprises a filling material in the form of granules 4.

The granules 4 therefore act as a filling material with respect to the materials used to make the padding element 2.

In this description, the use of the terms “granules” and “filling material” can be considered equivalent, when the opposite is not explicitly indicated.

A peculiar aspect of the present invention is that said filling material comprises and/or is made of a recycled material. In detail, the granules of the filler material comprise and/or are made, for example completely made, of a recycled material.

Preferably, the filling material consists only of the granules 4.

In particular, the recycled material of the granules 4 derives from a waste of at least one of: a production process of a support element, a discarded support element or a discarded part thereof, such as for example at least one of an external covering or cover, for example made of PVC and/or TPU, a padding element, made of an expanded material, at least one gel or elastomer insert of a padding element, a support base of a support element for the human body, such as for example a rigid or semi-rigid plastic material.

In particular, this recycled material and/or this waste includes at least two materials different in type and/or hardness and/or density and/or stiffness.

In particular, the recycled material includes or consists of at least one of an expanded material, such as a foam, for example polyurethane foam or EVA, an elastomeric material, an expanded thermoplastic material, a gel material, for example polyurethane gel, PVC, TPU (thermoplastic polyurethane), a plastic material, polypropylene, polyamide, or a mixture thereof. As mentioned, this recycled material can derive from a waste from the production process of a support element, such as a waste from the production or foaming process for the production of a support element.

The recycled material of the present invention does not include any metallic or metal alloy material.

According to a preferred embodiment of the invention, each granule 4 can comprise or be made of a mixed material such as:
expanded material (e.g. foam) and gel (or elastomer), or
expanded material (e.g. foam) and PVC/TPU (cover), or
expanded material (e.g. foam) and rigid or semi-rigid plastic material, or
gel (or elastomer) and PVC/TPU (cover), or
gel (or elastomer) and rigid or semi-rigid plastic material, or
PVC/TPU (cover) and rigid or semi-rigid plastic material, or
expanded material (e.g. foam), gel (or elastomer) and PVC/TPU (cover), or
expanded material (e.g. foam), gel (or elastomer) and rigid or semi-rigid plastic material, or
expanded material (e.g. foam), PVC/TPU (cover) and rigid or semi-rigid plastic material, or
gel (or elastomer), PVC/TPU (cover) and rigid or semi-rigid plastic material, or
expanded material (e.g. foam), gel (or elastomer), PVC/TPU (cover) and rigid or semirigid plastic material.

Naturally, various mixtures of the mixed granules are possible according to the present invention and depend on the type of material to be recycled that is used for the production of the granules themselves.

Furthermore or alternatively, each granule can be made up of a single material but, as a whole, the granules 4 comprise at least two materials different in type and/or hardness and/or density and/or stiffness (for example considering the possible combinations above listed).

As can be seen, therefore, the present invention guarantees a sort of circularity, as it starts from a support element or a part thereof which is for some reason discarded during the production process, this support element or part thereof is therefore completely recycled and then reused for the production of a new support element.

Even more in detail, taking the example of a bicycle saddle, when it or a part of it is discarded directly during the production step or after its use, it contributes (with the exception of the fork if made in a metallic material) to the partial or complete formation of the filling material in the form of granules 4 and therefore to the formation of the padding element 2 of the present invention.

The same can be said for a seat or a handlebar grip. Naturally, when the recycled material comes from a bicycle saddle, it can also be used to make a seat or a grip, as well as other saddles, and vice versa.

Usually, therefore, the recycled material includes at least one of a material of a cover or an external covering of a discarded support element, such as for example PVC and/or TPU, for example in the form of a layer or film having a thickness between 100 microns and 1000 microns, and/or a density of 500-1000 kg/m³, a material of a padding element of a discarded support element, such as an expanded material (e.g. a foam, e.g. polyurethane foam), for example having a density between 50 and 600kg/m³ , a gel material, for example polyurethane gel, or elastomer, for example having a density equal to 1000kg/m³ , and/or a sealing material, a material of a support base, for example a plastic material, such as for example polypropylene (PP) or polyamide (PA), for example rigid or semi-rigid. These materials—when present—are all in the form of granules 4, preferably with a substantially irregular shape.

Density is calculated as mass/volume. For example, for polyurethane foam the unit of measurement is kilograms of foam divided by m³ of saddle volume.

The padding element 2 of the present invention, therefore, or at least its component in expanded material, comprises a foam material, for example polyurethane foam, or EVA or an expanded thermoplastic, and this recycled material in the form of granules 4.

The recycled material can be present in a percentage w/w between 1% and 50% with respect to the total material of the padding element 2, or between 1% and 35% or between 5% and 35% or between 1% and 10% or between 5% and 15% or less than 25% or less than 35%, etc.

The granules 4 are homogeneously distributed within the volume of the padding element 2. This distribution is homogeneous from the point of view of at least one of position, density, type of material that makes up the granules 4 and/or stiffness.

It was unexpectedly demonstrated that the presence of the granules 4 of recycled material does not alter in any way the structural characteristics, flexibility, elasticity and/or comfort of the padding element 2 and therefore even high percentages of such materials can be inserted without problems for the end user. Similarly, the constraint and/or adhesion capabilities of the support element 1 to the support base 3 are not altered.

The support element 1 can comprise an external covering element 5, also called cover. Alternatively, the expanded material that constitutes the padding element 2 can be a self-skinning polyurethane foam, therefore capable of forming during the foaming or expansion step a protective film or layer close to the external surface of the padding element 2 itself. In that case, of course, the cover is not necessary.

By external covering element, therefore, we can mean both an actual cover and the film or protective layer formed by the self-skinning foam.

When the external covering element 5 is present, it can present one or more transparent windows 6. A transparent window is usually made of a material similar to that of the remaining external covering element 5 but with a transparent appearance. In this way, the underlying padding element 2 will be visible and with it, also the granules 4 of the filling material in the form of granules 4. In this way, it will be possible to verify the actual presence of this filling material and at the same time, obtain a peculiar aesthetic appearance for the support element 1. In fact, the possibility of giving a particular colour to the granules and/or contrasting colour with respect to the colour given to the remaining material of the padding element 2 is not excluded.

The presence of the granules 4, however, is perceptible even in the absence of transparent windows 6, as their presence inside the material that constitutes the padding element 2 determines a sort of roughness for the external covering element 5 or for the external covering created by the self-skinning foam. Therefore, the granules 4 are present not only in the volume of the padding element 2 but also at its external surface (the one that will come into contact with the cover or that will form the film or the protective layer when in the presence of self-skinning foam). Therefore, on an aesthetic level, even in the presence of an external covering 5, it is possible to glimpse or perceive the granules 4 present inside.

It can therefore be said that the cover or external covering 5 or even the film or protective layer have a “granular” texture, determined precisely by the granules 4.

According to a further version of the invention, the external covering element 5 is smooth and not wrinkled in at least one part or area thereof. Optionally, this part or area can be the one in contact with the at least one gel or elastomer insert.

The granules 4 have an average size (or diameter or thickness, considering that the shape of the granules 4 is not necessarily spherical or spheroidal, but can be irregular) of less than 10 mm or between 0.1 mm and 10 mm or between 1 mm and 10 mm or preferably between 3 mm and 6 mm or even more preferably 4 mm or less than 6 mm in diameter or less than 4 mm.

The granules 4 can therefore have a different density from granule to granule. In particular, the filler material can include more or less dense granules, more or less rigid granules, granules made from a single material or mixed granules made from two or more materials, granules with different specific weights, etc.

In order to obtain such granules 4, the material to be recycled is ground in a grinding step 10 thus obtaining a recycled material in the form of granules.

This recycled material in the form of granules can be stored in a single container suitable for this purpose.

This grinding step 10 can take place with traditional industrial grinding mills.

In at least one version of the present invention, the material to be recycled does not undergo any further processing, other than grinding, in order to obtain the granules 4.

The method for the production of a support element for the human body according to the present invention, therefore, comprises the steps of:
providing a material to be recycled,
grinding the material to be recycled obtaining granules 4 of filler material,
providing at least one material for the padding element 2 in the fluid state, preferably liquid,
possibly taking the granules 4 from a single container for their storage, for example taking a certain quantity of granules 4 based on its desired percentage,
mixing the granules 4 with the material in the fluid state, preferably liquid, obtaining a mixture,
providing a mould equipped with at least one female portion including a cavity having a shape at least partially corresponding to that of at least part of the support element 1 and/or of the padding element 2,
pouring or injecting the mixture into the cavity of the mould,
expanding or polymerizing the mixture, obtaining the padding element 2 and/or a component in expanded material of the padding element 2 comprising the filling material comprising the granules 4 which comprise and/or are made of recycled material.

In at least one version of the present invention, in order to obtain the component in expanded material comprising the granules 4, only the steps listed above are used.

In the expanding or polymerizing step, it is the material in the fluid state that will constitute the component in expanded material, which reacts and therefore expands and polymerizes. The granules 4, present within this material or in the mixture, are not involved in this step. The material that composes them, in fact, does not participate in the expansion or polymerization reaction, for example as this material is in an already expanded and polymerized state. It is clear that the liquid material in its expansion and polymerization step will incorporate the granule.

By “at least one material in the fluid state”, preferably liquid, it is meant, for example, the mixture of two materials A and B, which are mixed in a mixing head, for example A isocyanate and B a polyol formulation (i.e. at least a polyol and additives such as catalysts, cell regulators, colours, etc., for example according to a specific formulation based on the result to be obtained), which are in the liquid state, which by reaction will give rise to the formation of the expanded polyurethane polymer.

The granules 4 obtained by the grinding step 10 can be passed through at least one sieve, in a sieving step 20, so as to recover only those granules having the desired dimensions indicated above.

This step of passage through at least one sieve can take place through a hopper and/or a sieve with holes with a diameter of less than 10 mm or between 0.1 mm and 10 mm or between 1 mm and 10 mm or preferably between 3 mm and 6 mm or even more preferably of 4 mm or less than 6 mm in diameter or less than 4 mm.

According to an embodiment, granules larger than 6 mm cannot be processed in traditional foaming systems.

The peculiarity of the present invention, therefore, is precisely that of grinding and reusing a recycled material made up of several materials different in terms of type and/or hardness and/or density and/or nature (for example thermoplastic and/or thermosetting nature), such as those indicated in the present invention.

Furthermore, another peculiarity that strongly differentiates the present invention compared to traditional grinding methods is that no separation step occurs due to the density or characteristics of the different materials of which the granules are composed. The granules 4 of the present invention, in fact, as indicated, can have different characteristics from granule to granule and this does not compromise the subsequent steps of their use.

For this reason, the granules 4 can be stored in a single container.

The granules 4 are then mixed with the material in the fluid state, preferably liquid, which will constitute the padding element 2, in a mixing step 30, in order to obtain a mixture.

According to an embodiment, therefore, the granules 4 are fed to a foaming head, simultaneously with the material that will constitute the padding element 2 or there will be a prior strep of mixing the granules 4 with the material that will constitute the padding element 2 in the fluid state, preferably liquid, in order to obtain this mixture to be fed to the foaming head.

According to a version of the present invention, this mixing step 30 takes place using a suitable foaming machine or foaming head which allows the mixing of the granules by incorporating them into the at least one material in the fluid state, and/or into the foam and/or into the expanded material which constitutes/will constitute the padding element 2.

Specifically, according to an example, the foaming machine is the machine that mixes the materials A and B defined above, for the production of a polyurethane. The above definition, however, can take on a broader meaning, when the materials that will constitute the padding element 2 are not a polyurethane foam.

According to an embodiment, this foaming machine or foaming head is provided with a screw that feeds the granules into the mixing chamber together with the at least one material in the fluid state, preferably liquid, (for example at least one material A and B as defined above, for example at least one polyol and at least one isocyanate) which will constitute the padding element 2, obtaining the padding element 2 equipped with the expanded material component containing such granules.

A similar or same screw can feed the granules into a mixing chamber together with the material in the fluid state, preferably liquid, (for example at least one material A and B as defined above, for example at least one polyol and at least one isocyanate) which constitutes the at least one gel or elastomer insert containing these granules, when present.

The at least one gel insert is not formed (in at least one version of the present invention) by foaming but by casting and subsequent polymerization, as it is a compact material. In a further version, the at least one insert comprises a polyurethane elastomer, made by mixing isocyanate and polyol mixture. It can be compact or expanded, usually has hardness expressed in shore for applications such as rollerblade wheels, bicycle saddle springs, shoe midsole, etc. Polyurethane gel can be defined as soft elastomer.

The screw mentioned above is equipped with a hopper, i.e. a funnel which conveys the granule into the screw which will take it to the foaming head.

Therefore, the granules 4 according to the present invention are conveyed into the screw via the hopper. During this step, no separation or division occurs due to the different densities of the constituents of the granule and/or of the constituents of the different granules and, although the granules themselves are made of different materials, with different densities and/or different stiffnesses, they maintain their average distribution.

This aspect was not at all predictable. For example, considering that the granules can have different densities, it could be assumed that the heavier materials (for example a granule with a prevalence of plastic compared to a granule with a prevalence of foam) could arrive first in the screw, or during the granule dispensing step, but this did not happen.

As can be seen, on a general level, in at least one version of the present invention, it is possible to use the same machinery and/or the same moulds traditionally used for the production of the support element 1, despite the used material containing the filling material in the form of granules 4 is innovative compared to the usually used one.

The subsequent steps, in fact, can be the traditional ones for the production of support elements of a known type.

For example, there may be a step of preparing an external covering element 5 and a step of creating a vacuum in a female component of a mould in order to keep in position and/or conform this external covering element 5.

There may be a closing step of the female component of the mould by means of a male component equipped with a support base 3 or another component, obtaining a closed cavity.

Then there can be a pouring or injecting step 40 of the mixture (i.e. the material that constitutes the padding element 2 comprising the component in expanded material and the filling material in the form of granules 4) inside a cavity of the mould determined by the closure of the male component on the female component, as well as a subsequent polymerization or foaming step of this mixture with consequent filling of the cavity and obtainment of the padding element 2, possibly adhering and/or constrained to at least one of the external covering element 5 and the support base 3. In fact, during the expanding or polymerizing or foaming step, the consequent adhesion and/or consequent constraining of the padding element 2 to at least one surface of the support base 3 and/or to the external covering element 5 occurs.

Alternatively, when the padding element 2 is a self-skinning foam, during the step of expanding or polymerizing or foaming, the formation of the film or protective layer which acts as an external covering of the padding element 2 occurs.

It should be underlined that, in at least one version of the present invention, the filling material in the form of granules 4 does not include binders or other adhesive agents suitable for promoting the polymerization of the material itself. That is to say, this filling material is granular (for example consisting only of the granules 4 which are “solid” and/or “rigid”) and as such is added to the material suitable for constituting the component in expanded material of the padding element 2.

As can be seen from the above, no compression step is necessary in the mould, as it is the steps of pouring or injecting 40 the mixture and of polymerizing or foaming this mixture that allow the material to fill the mould cavity in which it is inserted and therefore to occupy the space corresponding to the shape it must take once finished. This is determined by the fact that the mixture containing the granules 4 is preferably in a liquid state and therefore occupies a part of the cavity intended for it without the need for compression, and then subsequently expands and occupies the entire cavity. In this way, the material of the granules 4 does not undergo compression and therefore maintains its original characteristics substantially unaltered, resulting in no discomfort for the user who should perceive its presence inside the padding element 2.

Furthermore, the material in the fluid state does not act as a glue, binder or adhesive as such for the granules contained therein but precisely from a structural point of view forms the component in expanded material of the padding element, guaranteeing the necessary comfort for the user.

Therefore, in the method according to the present invention there is no compression step of the granules 4 of the filling material nor of the mixture, nor of the component in expanded material of the padding element 2, so as not to alter the desired cushioning and/or or support characteristics of the support element 1.

Furthermore, no step of vibrating the granules material is necessary so as to make it take on a certain shape or compactness, as the granules 4 are homogeneously distributed in the mixture and therefore remain homogeneously distributed even during the polymerization or foaming step, which determines the obtaining of the finished padding element 2.

There may be a step of pouring a gel or elastomer material possibly equipped with the filling material in the form of granules 4 according to the present invention, for example into the cavity of the mould or in a specific seat, polymerizing or solidifying said gel or elastomer material with the obtainment of at least one gel or elastomer insert, possibly before the step of pouring or injecting the material that constitutes the component in expanded material or foam of the padding element 2.

Steps of trimming the external covering element 5 when present, further finishing processes, possible applications of a detaching material from the mould walls, possible steps of positioning decorative elements, logos, etc., possible obtainment of portions with different characteristics of compactness and/or stiffness and/or deformability compared to the support element 1 or its remaining part, etc., depending on the type of support elements 1 that is intended to be created, can follow.

When a gel or elastomer insert is present in the support element according to the present invention, it can be positioned at at least one transparent window 6. The gel or elastomer, in fact, is also usually transparent and this allows better visibility of the granules 4 present in the gel or elastomer itself and/or in the component in expanded material or foam that will constitute the padding element 2.

Furthermore, thanks to the specific characteristics of the gel or elastomer, it makes it possible not to perceive, to an even greater extent, the presence of such granules inside the support element 1.

Furthermore, when the gel or elastomer insert does not contain the granules material according to the present invention, being generally placed between the contact surface with the user and the component in expanded material of the padding element 2, this gel or elastomer insert “separates” or “distances” the granules 4 present in the padding element 2 and the user. Therefore, the comfort for the latter is not minimally compromised by the presence of the filling material in the form of granules 4, nor by the mixed and/or rigid nature of the granules 4 themselves in recycled material.

In this way, the comfort of the support element is indistinguishable when compared with similar support elements without the filling material of the present invention.

Naturally, the granules 4 of the present invention, when the padding element 2 is made of a self-skinning foam, can also be present at the external covering which intrinsically forms the self-skinning foam itself, or in any case on the most external or visible surface of the support element 1, i.e. that surface capable of coming into contact with the user. According to a further version of the present invention, in order to make the presence of the granules 4 evident from the outside, it would be possible to provide at least one “transparent” window also at the support base 3. In this way, this transparent window can be opened (with direct access to the material that constitutes the padding element 2) or closed by a transparent material of the same type as that which constitutes the support base 3 or having a different nature or resistance.

According to a version of the present invention, the granules 4 could also be made up of agglomerates of granules 4. For example, the granules obtained from grinding the expanded material or foam parts of the recycled material could give rise to adhesion phenomena compared to granules obtained from different materials, facilitating the formation of granule agglomerates. The granules formed by grinding gel or elastomer parts could have a similar capacity. In this case, the agglomerates possibly have an average size, diameter or thickness of less than 10 mm or less than 6 mm or less than 5 mm or less than 4 mm. The minimum size of the granules and/or agglomerates, according to at least one version of the present invention, is equal to 1 mm or 2 mm or 3 mm.

As can be seen from the present description, in order to be able to insert the granules 4 into the material that constitutes the padding element 2, no chemical additives or compatibilizers of any kind are used. The granules 4, in fact, are exactly as they come out of the grinding and sieving process.

Thanks to the present invention, therefore, all the indicated waste, instead of ending up in landfill or being disposed of with considerable costs both in economic and environmental terms, return in a circular manner to form a new support element, of the same or similar type or even different from that from which such waste derives. In this way, these wastes are 100% recovered and do not need to be separated by type of material or characteristics nor do they require chemical agents or compatibilizers for their further use.

It has therefore been seen that this process, and the resulting product, are very simple and do not require complex separation operations of materials of different nature from the waste from which the granules 4 derive.

In fact, it must be considered that there is a “physiological” waste, for example of 5%, in the production of bicycle saddles for example and with the present invention this waste is eliminated as the discarded material is reused for the production of new saddles.

Characteristics defined for one variant or embodiment may also be present for other variants or embodiments, unless the opposite is explicitly provided for.

Modifications and variations of the invention are possible within the scope of protection defined by the claims.

1. A support element for the human body, wherein said support element is a bicycle or vehicle saddle, a seat, a grip for a bicycle handlebar or for a vehicle, wherein said support element comprises a padding element, comprising at least one component in expanded material and constrainable to at least one surface of a support base, wherein said component in expanded material includes granules, wherein said granules comprise and/or are made of a recycled material, wherein said recycled material of said granules is made up of at least two materials different in type and/or hardness and/or density and/or stiffness, and derives from a waste of at least one of: a production process of a support element, a discarded support element or a discarded part thereof, such as for example at least one part of an external covering or cover, a padding element, made in at least one expanded material, at least one gel or elastomer insert, a support base of a support element for the human body, made for example of a rigid or semi-rigid plastic material.

2. The support element according to claim 1, wherein said granules comprising and/or made of said recycled material comprise or consist of at least one or at least two of: said expanded material, for example a foam, for example a polyurethane foam, ethyl vinyl acetate (EVA), an expanded thermoplastic material, an expanded material having a density between 50 kg/m³ and 600kg/m³ , and/or an elastomeric material, a gel material, for example polyurethane gel, or an elastomer, for example having a density equal to 1000 kg/m³ , and/or PVC, TPU, and/or a rigid or semi-rigid plastic or polymeric material, polypropylene, polyamide, for example a plastic or polymeric material having a density of 500-1000 kg/m³ or a mixture thereof.

3. The support element according to claim 1, wherein each granule comprises or is made of a mixed material comprising at least two of the following materials:
expanded material, for example recycled from a foam or padding element, and/or
gel or elastomer material, for example recycled from an insert of a padding element, and/or
PVC and/or TPU, for example recycled from a cover, and/or
a rigid or semi-rigid plastic material, for example recycled from a support base of a support element for the human body.

4. The support element according to claim 1, wherein said recycled material resulting from said waste of a production process of a support element is a waste of a foaming process for the production of a support element, and/or wherein said recycled material does not include any metallic or metal alloy material.

5. The support element according to claim 1, wherein said granules are homogeneously distributed in said padding element and/or in said component in expanded material from the point of view of at least one of positions, density, nature, type of material that makes up said granules and/or stiffness and/or wherein said granules have an irregular conformation and/or wherein said granules have an average size of less than 10 mm or between 0.1 mm and 10 mm or between 1 mm and 10 mm or preferably between 3 mm and 6 mm or even more preferably of 4 mm or less than 6 mm in diameter or less than 4 mm.

6. The support element according to claim 1, wherein said component in expanded material of said padding element is made of a foam, for example a polyurethane foam, a self-skinning polyurethane foam, an expanded polyurethane polymer formed by the reaction of a material A, such as for example isocyanate, and a material B, such as for example a polyol formulation comprising at least one polyol and at least one additive such as at least one of a catalyst, a cellular regulator, a colour, etc., an expanded thermoplastic, EVA, an expanded material having a density between 50 kg/m³ and 600 kg/m³ , or a combination thereof.

7. The support element according to claim 1, wherein said padding element includes at least one gel or elastomer insert in addition to said component in expanded material, and wherein said granules are present in said component in expanded material and, if desired, also in said at least one gel or elastomer insert.

8. The support element according to claim 1, wherein said recycled material is present in a w/w percentage with respect to the total material of said padding element between 1% and 50%, or between 1% and 35% or between 5% and 35% or between 1% and 10% or between 5% and 15% or less than 25% or less than 35%.

9. The support element according to claim 1, wherein said support element includes an external covering element, possibly equipped with one or more transparent windows, in order to make said granules visible from the outside.

10. The support element according to claim 1, wherein said padding element comprises a self-skinning polyurethane foam which intrinsically forms during its expansion or polymerization an external covering element, wherein said granules are possibly also present at said external covering element.

11. The support element according to claim 9, wherein said external covering element has a rough or granular appearance and this appearance is determined by the at least internal presence of said granules

12. A method for the realization of a support element for the human body, wherein said support element is a bicycle or vehicle saddle, a seat, a grip for a bicycle handlebar or for a vehicle, according to one or more of the previous claims, wherein said support element comprises a padding element, constrainable to at least one surface of a support base, wherein said padding element comprises granules, comprising the following steps:
providing a material to be recycled resulting from a waste of at least one of: a production process of a support element, a discarded support element or a discarded part thereof, such as for example at least one of an external covering or cover, a padding element, made of at least one expanded material, at least one gel or elastomer insert, a support base of a support element for the human body, made for example of a rigid or semi-rigid plastic material, wherein said waste includes at least two materials different in type and/or hardness and/or density and/or stiffness,
grinding said material to be recycled obtaining said granules, wherein said recycled material of said granules is made up of said at least two materials different in type and/or hardness and/or density and/or stiffness, and
providing at least one material for said padding element in the fluid state,
mixing said granules with said at least one material in the fluid state obtaining a mixture,
providing a mould equipped with at least one female portion comprising a cavity having a shape at least partially corresponding to that of at least part of said support element and/or that of said padding element,
pouring or injecting said mixture into said cavity of said mould,
expanding or polymerizing said mixture obtaining at least one component in expanded material of said padding element,
providing a support base,
closing said cavity of said mould with a male component on which said support base has been positioned and/or constrained, obtaining a closed cavity, so as to allow said step to expanding or polymerizing in said closed cavity, with consequent adhesion and/or constraint of said padding element to at least one surface of said support base,
characterized by the fact of obtaining said at least one component in expanded material of said padding element comprising said granules which comprise and/or are made of said recycled material.

13. The method according to claim 12, wherein said step of providing at least one material for said padding element in the fluid state comprises providing a material A, such as for example isocyanate, and a material B, such as for example a polyol formulation comprising at least one polyol and at least one additive such as at least one of a catalyst, a cellular regulator, a colour, etc., wherein said material A and said material B are capable of reacting to form an expanded polyurethane polymer, a material capable of forming a foam, for example a polyurethane foam, a self-skinning polyurethane foam, an expanded thermoplastic, EVA, an expanded material having a density between 50 kg/m³ and 600 kg/m³ , or a combination thereof.

14. The method according to claim 12, comprising a step of sieving said granules to select said granules having an average size less than 10 mm or between 0.1 mm and 10 mm or between 1 mm and 10 mm or preferably between 3 mm and 6 mm or even more preferably 4 mm or less than 6 mm in diameter or less than 4 mm.

15. The method according to claim 12, comprising a step of providing a covering element, optionally equipped with one or more transparent windows, creating a vacuum in said cavity of said mould, positioning and/or shaping said covering element into said cavity.

16. The method according to claim 15, wherein during said expanding or polymerizing step the adhesion and/or constraining of said padding element to said external covering element occurs.

17. The method according to claim 12, comprising a step of providing a gel or elastomer material, optionally mixing said granules with said gel or elastomer material, pouring or inserting said gel or elastomer material into said cavity or in an area thereof, polymerizing or reacting said gel or elastomer material obtaining at least one gel or elastomer insert in said padding element possibly at or close to said external covering element before said step of pouring or injecting said mixture which will constitute said at least one component in expanded material of said padding element

18. The method according to claim 12, wherein said method does not include any compression step of said granules nor of said mixture, nor of said component in expanded material of said padding element, in so as not to alter the cushioning and/or support characteristics of said support element.

19. The method for the realization of a padding element of a support element for the human body, wherein said support element is a bicycle or vehicle saddle, a seat, a grip for a bicycle handlebar or for a vehicle, according to claim 1, wherein said padding element can be constrained in use to at least one surface of a support base, comprising the following steps:
providing a material to be recycled resulting from a waste of at least one of: a production process of a support element, a discarded support element or a discarded part thereof, such as for example at least one of an external covering or cover, a padding element, made of at least one expanded material, at least one gel or elastomer insert, a support base of a support element for the human body, made for example of a rigid or semi-rigid plastic material, wherein said waste includes at least two materials different in type and/or hardness and/or density and/or stiffness,
grinding said material to be recycled obtaining granules, wherein said recycled material of said granules is made up of said at least two materials different in type and/or hardness and/or density and/or stiffness, and
providing at least one material for said padding element in the fluid state, preferably liquid,
mixing said granules with said at least one material in the fluid state obtaining a mixture,
providing a mould equipped with at least one female portion including a cavity having a shape at least partially corresponding to that of at least part of said padding element,
pouring or injecting said mixture into said cavity of said mould,
expanding or polymerizing said mixture obtaining at least one component in expanded material of said padding element,
characterized by the fact of obtaining said at least one component in expanded material of said padding element comprising said granules which comprise and/or are made of said recycled material.

20. The method according to claim 19, wherein said step of providing at least one material for said padding element in the fluid state comprises providing a material A, such as for example isocyanate, and a material B, such as for example a polyol formulation comprising at least one polyol and at least one additive such as at least one of a catalyst, a cellular regulator, a colour, etc., wherein said material A and said material B are capable of reacting to form an expanded polyurethane polymer, a material capable of forming a foam, for example a polyurethane foam, a self-skinning polyurethane foam, an expanded thermoplastic, EVA, an expanded material having a density between 50 kg/m³ and 600 kg/m³ , or a combination thereof.

21. The method according to claim 19, comprising at least one of the following steps:
sieving said granules to select said granules having an average size of less than 10 mm or between 0.1 mm and 10 mm or between 1 mm and 10 mm or preferably between 3 mm and 6 mm or even more preferably 4 mm or less than 6 mm in diameter or less than 4 mm,
providing a covering element possibly equipped with one or more transparent windows, creating a vacuum in said cavity of said mould, positioning and/or shaping said covering element in said cavity, wherein during said expanding or polymerizing step, the adhesion and/or constrain of said padding element to said external covering element occurs,
providing a gel or elastomer material, possibly mixing said granules with said gel or elastomer material, pouring or inserting said gel or elastomer material into said cavity or an area thereof, causing said material to polymerize or react or solidify said gel or elastomer material obtaining at least one gel or elastomer insert in said padding element, possibly at or close to said external covering element, before said step of pouring or injecting said mixture which will constitute said at least one component in expanded material of said padding element.
